(19) United States
(12) Patent Application Publication
(10) Pub. No.: US 2012/0323941 A1
(43) Pub. Date: Dec. 20, 2012

(54) Processing Queries for Event Data in a Foreign Representation

(75) Inventors: Gueorgui Bonov Chkodrov, Redmond, WA (US); Colin Joseph Meek, Kirkland, WA (US); Tihomir Tsvetkov Tarnavski, Redmond, WA (US); Balan Sethu Raman, Redmond, WA (US); Beysim Sezgin, Redmond, WA (US)

(73) Assignee: MICROSOFT CORPORATION, Redmond, WA (US)

(21) Appl. No.: 13/163,435

(22) Filed: Jun. 17, 2011

(51) Int. Cl. G06F 17/30

(52) U.S. Cl. 707/756; 707/E17.014; 707/E17.126

(57) ABSTRACT

The subject disclosure is directed towards processing a query corresponding to event data in a foreign representation. In order to produce results for the query, an event structure is defined for each requested event type. Information is automatically generated for configuring adapters to identify attribute data associated with the each requested event type and return the attribute data according to the event structure. These adapters search historical event data or real-time event data for the event-related data.

### BACKGROUND

Monitoring applications are developed from various complex event processing platforms for analyzing event data. These applications, via an interface, access the event data by creating an adapter at one or more sources that translates a foreign representation of the event data into event types defined by the applications. The foreign representation refers to any representation that is not native to a specific complex event processing platform. The sources include various devices, such as computers, mobile phones, sensors (e.g., Radio Frequency ID tags) and/or the like. Then, the applications communicate another foreign representation of the event data to output adapters that present such data to one or more third parties.

In each application, a developer manually defines components for each of the event types. These components include identifiers, timestamps and other data. The developer uses these components to build queries in an advanced query language. Furthermore, the developer manually configures each adapter with mappings between a native data format and the components of each event type. Because each event type is defined differently by disparate sources, the developer creates several versions in order to ensure compatibility.

At present, the developer cannot create applications without being concerned with configuring each adapter individually. This causes difficulties to organizations that want to monitor their processes.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed to processing queries for event data in a foreign representation. By automatically configuring adapters at sources of the event data, developers can write applications that use common event types instead of defining an event structure to be compatible with each data format in use. On behalf of such applications. a configuration mechanism associated with a complex event processing platform defines such an event structure based on the common event type. In one aspect, an adeptor running at the sources utilizes the event structure for searching both real-time event data and historical event data.

### BRIEF DESCRIPTION OF THE DRAWINGS

The present invention is illustrated by way of example and not limited in the accompanying figures in which like reference numerals indicate similar elements and in which:

FIG. 1 is a block diagram illustrating an exemplary system for processing queries for event data in a foreign representation.

FIG. 2 illustrates event structures implemented as generated C# classes.

FIG. 3 illustrates a logical model of classes for configuring at least one adapter running on at least one source.

FIG. 4 is a flow diagram illustrating exemplary steps for processing queries for event data in a foreign representation.

FIG. 5 is a flow diagram illustrating exemplary steps for automatically generating configuration information for at least one adapter.

FIG. 6 is a flow diagram illustrating steps for mapping components of an event in a foreign representation to components of at least one event structure.

FIG. 7 is a flow diagram illustrating steps for building and executing a query that uses common event types.

FIG. 8 is a block diagram representing an exemplary system for monitoring processes and providing event data in any representation.

FIG. 9 is a block diagram illustrating query execution on real-time event data in a foreign representation.

FIG. 10 is a flow diagram illustrating steps for responding to a query using configuration information.

FIG. 11 is a flow diagram illustrating exemplary steps for transforming event data into at least one event stream using configuration information.

FIG. 12 is a block diagram illustrating query execution on historical event data in a foreign representation.

FIG. 13 is a block diagram representing an exemplary system for executing a distributed query for real-time or historical events across a plurality of sources.

FIG. 14 is a graphical representation illustrating physical streams for executing a query.

FIG. 15 illustrates an event stream in a perspective of a developer.

FIG. 16 is a block diagram representing exemplary non-limiting networked environments in which various embodiments described herein can be implemented.

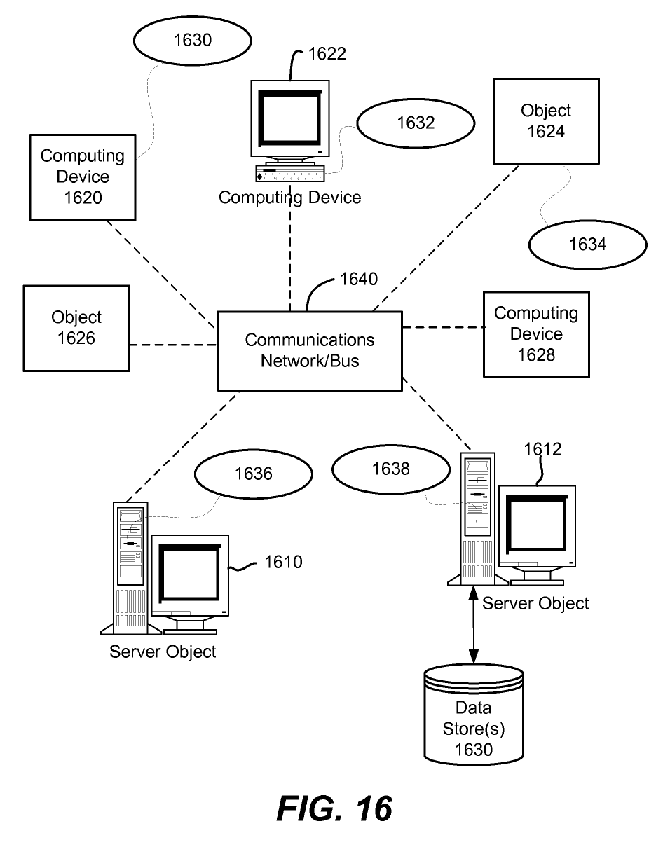

FIG. 17 is a block diagram representing an exemplary non-limiting computing system or operating environment in which one or more aspects of various embodiments described herein can be implemented.

### DETAILED DESCRIPTION

Various aspects of the technology described herein are generally directed towards processing queries for event data in a foreign representation that is stored across one or more sources. In one exemplary implementation, the one or more sources include computers that provide real-time event data as sessions or traces. In an alternate implementation, the one or more sources include files comprising historical event data (e.g., an event log). These files are created by the computers during various system activities and processes.

In one exemplary implementation, the event data is referred to as heterogenous for comprising several data formats (e.g., performance counters, event trace logs, XEvents, SQL tables, text files and/or the like). Such event data is created by a plurality of computers running various event monitoring and correlation software and/or hardware. These systems log various types of events as well as other event data, such as performance counters. In order to identify events of a certain type, a configuration mechanism defines an event structure that corresponds with one or more data formats.

An adapter running on a source uses the event structure to create a stream comprising the events of the certain type. Instead of an end-user or a developer defining the event structure, the configuration mechanism may automatically generate the event structure and configure the adapter; (note that it is feasible to use a manually configured adapter or one that is partially generated automatically, and partially generated manually).

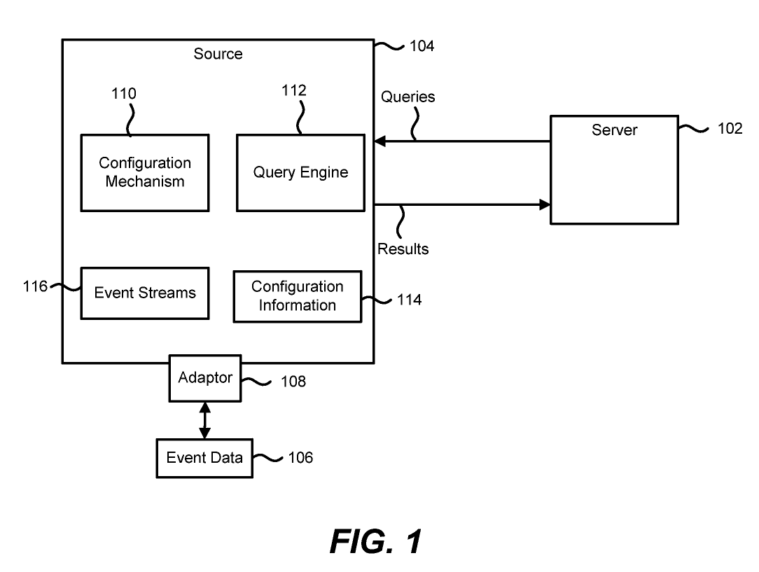

FIG. 1 is a block diagram illustrating an exemplary system for processing queries for event data in a foreign representation. A server 102 is coupled to a source 104 of event data 106. It is appreciated that in other implementations the server 102 is coupled to a plurality of sources. At each source 104, an adapter 108 are configured to translate event data in one or more data formats into one or more events having an event structure. Such an event structure may include a particular event type in use at the source 104. In one exemplary implementation, events of the particular event type are recorded by a provider, such as a manifest based provider.

The one or more data formats include representations of the event data. Accordingly, terms “data format” or “representation” are used interchangeably herein. Furthermore, a foreign representation is a data format used by various event data providers and consumers. In one exemplary implementation, the foreign representation includes any representation other than one utilized by a complex event processing platform.

A configuration mechanism 110 defines the event structure based on a query provided by a user via a query engine 112. As described herein, the event structure includes various components, such as attributes and methods, which map to content associated with a type of event (i.e., system event) that is recorded by the plurality of sources 104. In one exemplary implementation, the event structure implements a pre-defined or custom event type that is similar to event type being recorded by the source 104 as the event data 106. For example, start and stop events for operating system processes include timestamps, identifiers (e.g., process id or activity id) and/or other event data. In another example, HTTP or HTTPS services include identifiers, response times for requests (i.e., parsing and sending), security token information and other event data. The event structure may also define one or more counters, such as resource usage statistics (e.g., percent of total processor (CPU) time).

In one implementation, the event structure indicates whether the adapter 108 returns historical event data or real-time event data. Historical event data is stored in a data file (e.g., a comma separated values file (CSV), a event trace log file (ETL)), whereas the real-time event data is managed as dynamic sessions in which event-related data is examined incrementally while in-flight (i.e., stored in non-volatile memory). In yet another implementation, the event structure includes a time component indicating a specific time period of interest. In response, the adapter 108 provides historical event data and/or real-time event data within such a time period.

The event structure, according to one exemplary implementation, defines identifiers for one or more providers running on the source 104, such as manifest-based providers. As explained herein, these providers provide definitions for any data format currently in use and are associated with unique identifiers. A translation mechanism within the adapter 108 uses these unique identifiers to identify events that are recorded by these providers. These events are translated into events having the event structure.

In order to provide meaningful results for the query, the query engine 112 utilizes various event-related data, such as start and end timestamps, stored within one or more streams (e.g., Complex Event Processing (CEP) streams) that correspond with the event structure. As an example, if the user desires to know how many processes that did not complete execution within five (5) seconds, the configuration mechanism 110 generates an event structure for a process start event and another event structure for a process stop event. Each event structure includes at least one timestamp based on an internal system clock at one of the plurality of sources 104. These event structures may include similar components, but of different data types. The configuration mechanism 110 stores these event structures as configuration information 114.

The configuration mechanism 110 applies the configuration information 114 to adapter 108 running on the source 104. The adapter 108 responds with attribute data including timestamps for each process start and process stop event. In one implementation, the configuration mechanism 110 receives the event-related data as one or more streams 116 in which each unit includes either a process start event or a process stop event.

The query engine 112 examines the one or more streams 116 and identifies each pair of start and stop events by a corresponding process identifier. Using the timestamps, the query engine 112 determines a duration for each process and identifies any process that completed execution after five seconds elapsed. Because the configuration mechanism 110 generates and maintains the configuration information 114, the query engine 112 and similar applications only identify a generic event type when building the query as opposed to defining an event structure that maps to each data format. Hence, the system monitoring applications can generate queries using a generic query language.

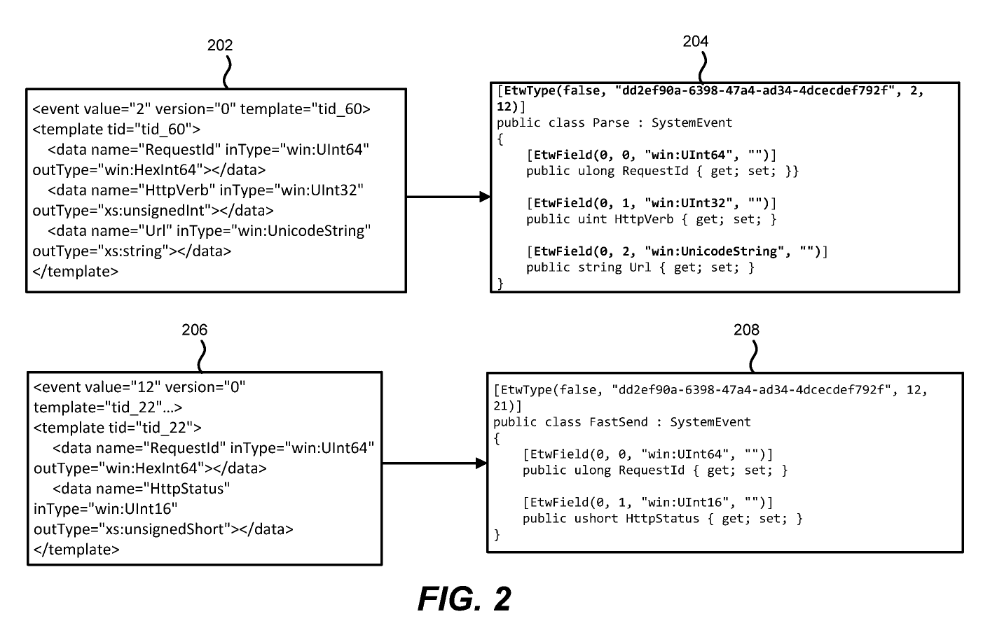

FIG. 2 illustrates event structures implemented in generated C# classes. Specifically, FIG. 2 refers to events used to process HTTP requests at a web server. In one exemplary implementation, components of a “parse” event are described in a manifest 202 with corresponding data types. These components are mapped to components of the event structure in other data types. For example, a “request ID” of the foreign representation is translated into a data type associated with a corresponding “request ID” component of the event structure. Then, the corresponding “request ID” is stored as an attribute of a generated C# class 204.

A “fastsend” event occurs after the “parse” event and completes the processing of a single HTTP request. Similar to the “parse” event, the foreign representation of the “fastsend” event is published in a manifest 206 and translated into an event structure of a custom “fastsend” event. During the translation, components of the event structure are named using data names from the manifest 206. As illustrated, corresponding components of the event are named “request ID” and “HTTPstatus.” Then, attributes of a C# class 208 are created using the corresponding components. Using the C# class 204 and the C# class 208, event data in the foreign representation defined by the manifest 202 and the manifest 206 is converted into event data in a custom representation.

In one exemplary implementation, a query engine uses the following code to execute a query for aggregating duration between the “parse” event and the “fastsend” event that correspond with a same request. Instead of defining a representation for the “parse” event and the “fastsend” event using information from the manifest 202 and the manifest 204, a developer uses automatically configured adapters to process event data.

```
namespace HttpQuery
{
  using System;
  using Microsoft.ComplexEventProcessing;
  using Microsoft.ComplexEventProcessing.Linq;
  using Microsoft.TraceInsight.Etw;
  class Program
  {
    static void Main(string[ ] args)
    {
  Server server = Server.Create(“Default”);
  StreamScope scope = new StreamScope(server, false); // false is past, true is real-
time
  scope.AddEtlFile(“..\\..\\HTTP_Server.etl”);
  var parse = scope.GetEtwStream<Microsoft_Windows_HttpService.Parse>( );
  var send = scope.GetEtwStream<Microsoft_Windows_HttpService.FastSend>( );
  var requests = parse.FollowedBy(send, TimeSpan.MaxValue, (p)=>p._ActivityId,
  (s)=>s._ActivityId, (p, s) => new
                {
                    Timestamp = p._Timestamp.ToFormattedString( ),
                    ActivityId = p._ActivityId,
                    Url = p.Url,
                    Status = s.HttpStatus,
                    Duration = s._Timestamp − p._Timestamp
                });
  var summary = from r in requests
      group r by new
            {
              Milliseconds = Math.Ceiling(r.Duration.TotalMilliseconds * 10) / 10,
              Url = r.Url,
              Status = r.Status
            }
      into eachGroup
      from window in eachGroup.TumblingWindow(TimeSpan.FromDays(365),
HoppingWindowOutputPolicy.ClipToWindowEnd)
                select new
                {
                    Url = eachGroup.Key.Url,
                    Status = eachGroup.Key.Status,
                    Milliseconds = eachGroup.Key.Milliseconds,
                    Count = window.Count( )
                };
  // use PlayStream when there is only one output stream
        // this internally will call Scope.Start( )
        var enumerable = scope.PlayStream(summary);
        // the stream-query ends here, producing the enumerable (iterator over
  small collection)
        // let's sort this using LINQ-to-objects
        var sorted = from e in enumerable orderby e.Url, e.Milliseconds select e;
        foreach (var sample in sorted)
        {
        Console.WriteLine(“{0,5} {1,5} {2}”, sample.Milliseconds, sample.Count,
sample.Url);
        }
    }
  }
}
```

The code listed above produces the following exemplary output:

| Time (Milliseconds) | Count | URL |
|---|---|---|
| 0.2 | 199 | http://georgis2:80/helloworld.htm |
| 0.3 | 72 | http://georgis2:80/helloworld.htm |
| 0.4 | 9 | http://georgis2:80/helloworld.htm |
| 0.5 | 1 | http://georgis2:80/helloworld.htm |
| 0.7 | 1 | http://georgis2:80/helloworld.htm |
| 0.9 | 1 | http://georgis2:80/helloworld.htm |
| 0.5 | 6 | http://georgis2:80/windir.txt |

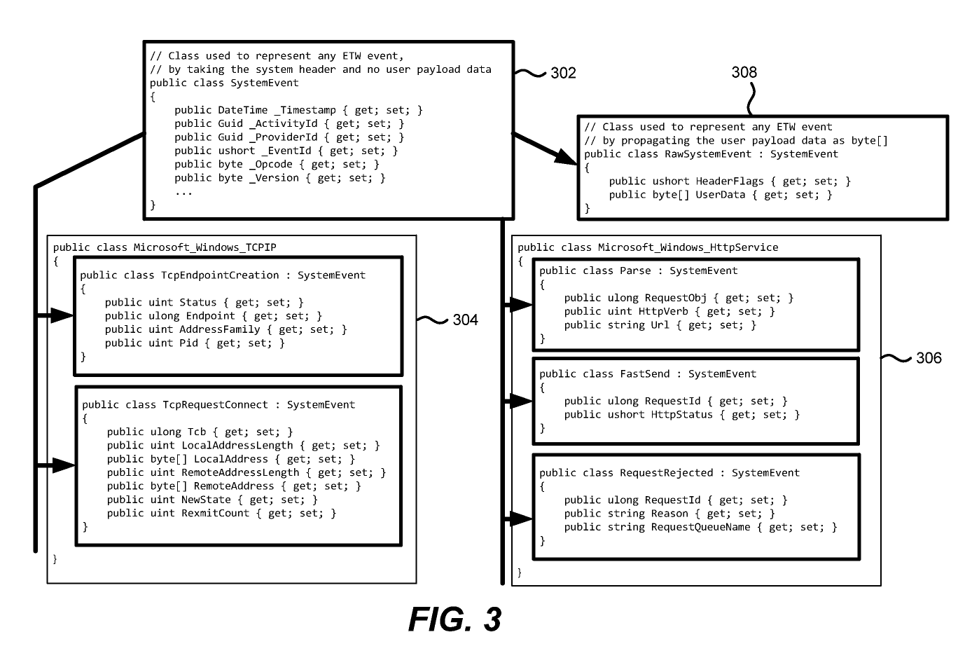

FIG. 3 illustrates a logical model of generated C# classes for configuring at least one adapter running on at least one source. The at least one adapter uses the logical model to install a translation mechanism, such as the configuration mechanism 110 of FIG. 1. When a developer queries historical event data or real-time event data, a configuration mechanism, such as the configuration mechanism of FIG. 1, automatically generates the logical model. Each query references at least one event by type. It is appreciated that a certain event may be implemented differently by different providers and/or stored across many files.

The configuration mechanism uses a common class 302 labeled “SystemEvent” to arrange various event classes into a hierarchy. As illustrated, a “TcpEndPointCreation” event class and a “TcpRequestConnect” event class derive from the common class 302. The translation mechanism uses these event classes to translate event data in a foreign representation that is generated by a provider 304 labeled Microsoft Windows TCPIP. Similarly, the translation mechanism uses a “Parse” event class, a “FastSend” event class and a “RequestRejected” event class to translate event data produced by a provider 306 labeled Microsoft Windows HTTPservice. For traces 308, such as ETW events, a “RawSystem Event” event class is used to perform the translation.

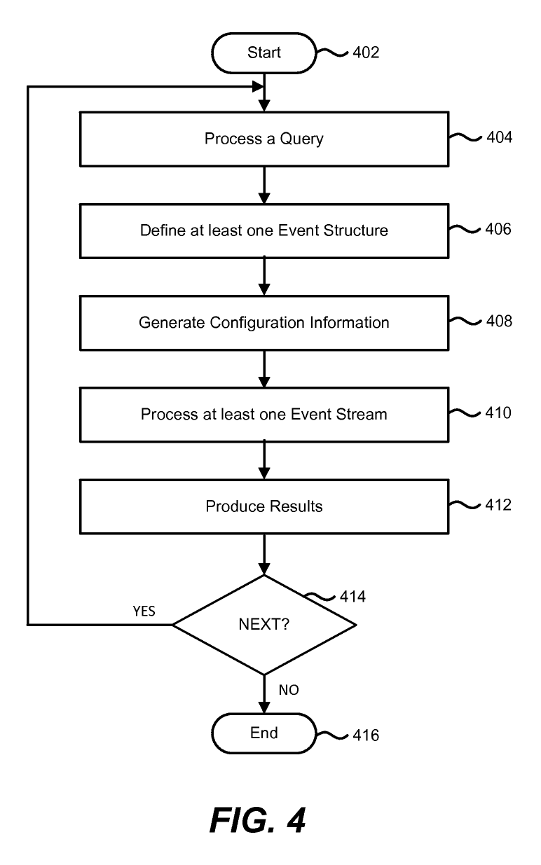

FIG. 4 is a flow diagram illustrating exemplary steps for processing queries for event data in a foreign representation. In one implementation, the step 402 to step 416 are performed by various software modules, such the configuration mechanism 110 and the query engine 112 of FIG. 1 as described herein. Steps depicted in FIG. 4 commence at step 402 and proceed to step 404 when a query for event data is processed.

Step 406 represents defining at least one event structure for translating the event data from a foreign representation into one or more common event types. In one exemplary implementation, the foreign representation refers to a single data format that is used by a provider to store events of various types. Some of these events correspond with the one or more common event types. Accordingly, each common event type is used to extract attribute data from a corresponding event in the foreign representation. In one implementation, a configuration mechanism generates mappings between components of the foreign representation and components of an event structure. As a result, the configuration mechanism 110 can refer to each component by a common or generic name instead of one that is specific to a certain foreign representation.

Step 408 is directed to configuration information generation and subsequent application to one or more adapters. In one implementation, the translation mechanism stores the mappings in the configuration information and configures the one or more adapters to return attribute data according to the components of the at least one event structure. The attribute data is stored in one or more event streams. In one implementation, a plurality of adapters search event data scattered across a plurality of computers by generating a distributed query.

Step 410 illustrates processing of at least one event stream from the one or more adapters. A unit of each event stream includes attribute data for a single event. In one exemplary implementation, a source of heterogeneous event data is mapped to a polymorphic event stream comprising events of different types and/or different formats. Step 412 refers to producing results for the query using the at least one event stream. In one exemplary embodiment, the configuration mechanism 110 uses the query engine 112 to perform an execution plan for the query. Using the components of the at least one event structure, the query engine 112 invokes operators, such as From, Join and Aggregate, that produce results for the query. Step 414 represents a determination as to whether to process another query. If a next query arrived at the query engine, step 404 to 414 is repeated. If, on the other hand, there are no more queries to be processed, step 416 terminates the processing of queries for event data.

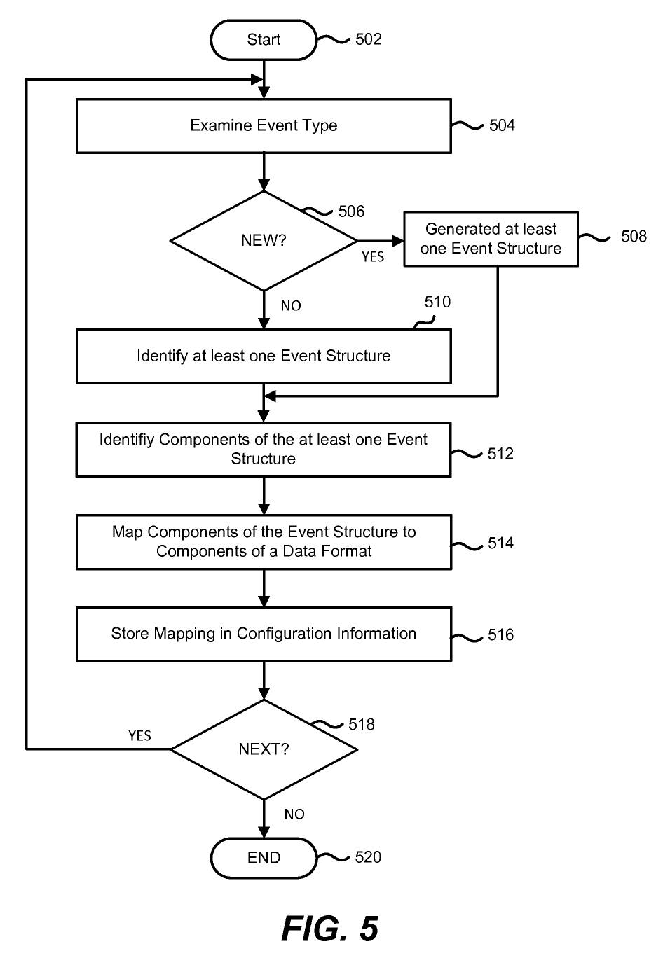

FIG. 5 is a flow diagram illustrating exemplary steps for automatically generating configuration information for at least one adapter. Steps depicted in FIG. 5 commence at step 502 and proceed to step 504 where a event type is examined. In one implementation, the steps 502 to 520 constitute embodiments of step 206 and step 208 of FIG. 2 and are performed by various software modules, such the configuration mechanism 110 of FIG. 1 as described herein. Accordingly, step 504 is performed after identifying one or more event types for responding to a query.

Step 506 determines whether the event type is a new event type. If the event type is new, step 508 is performed during which an event structure for the event type is generated. In one exemplary implementation, a file stores definitions for a data format that represents event data of interest. For example, a trace message format (TMF) file is a structured text file that includes instructions for parsing and formatting a binary trace messages generated by a trace provider. These formatting instructions are included in the trace provider's source code and are added to the trace provider's PDB symbol file. The formatting information can be extracted directly from a PDB symbol file. A name of the TMF file is the message GUID of binary trace messages used by the trace provider. For example, ETW uses the message GUID to associate particular trace messages with the TMF file that stores the formatting instructions.

Components of the data format are mapped to components of an event structure. A class is an embodiment of the event structure, which can be used for certain system monitoring systems. In one implementation, the C# class for the event type is generated based on a manifest associated with the data format. Similar to the TMF file, a manifest includes published definitions for one or more components of the data format. A corresponding component is defined in the C# class with a same or different data type. In one implementation, the manifest includes the following components for identifying each event type: ProviderGuid, EventID and Version. In alternate implementations, the components include an EventGuid, Opcode and Version.

After performing step 508, the configuration information generation process proceeds to step 512. If the event type is not new, step 510 represents identification of a known or common event structure that corresponds with the generic event type. Step 512 illustrates mapping of components of the event structure to components of one or more data formats. It is appreciated that the one or more data formats refers to any data format being employed at a source of events that corresponds with the generic event type. Step 514 refers to storing each mapping in configuration information. As a result, an adapter can be generated at each source for the purpose of identifying each matching event and extracting requested event-related data from event data. As described herein, the adapter organizes the event-related data in accordance with the event structure and creates a unit of an event stream to be communicated to the translation mechanism.

Step 516 represents a determination as to whether there are more event types from which to extract various attributes for configuring the adapters. If there is a next event type, the configuration information generation process returns to step 504. If there are no more generic event types to translate, step 518 terminates the configuration information generation process.

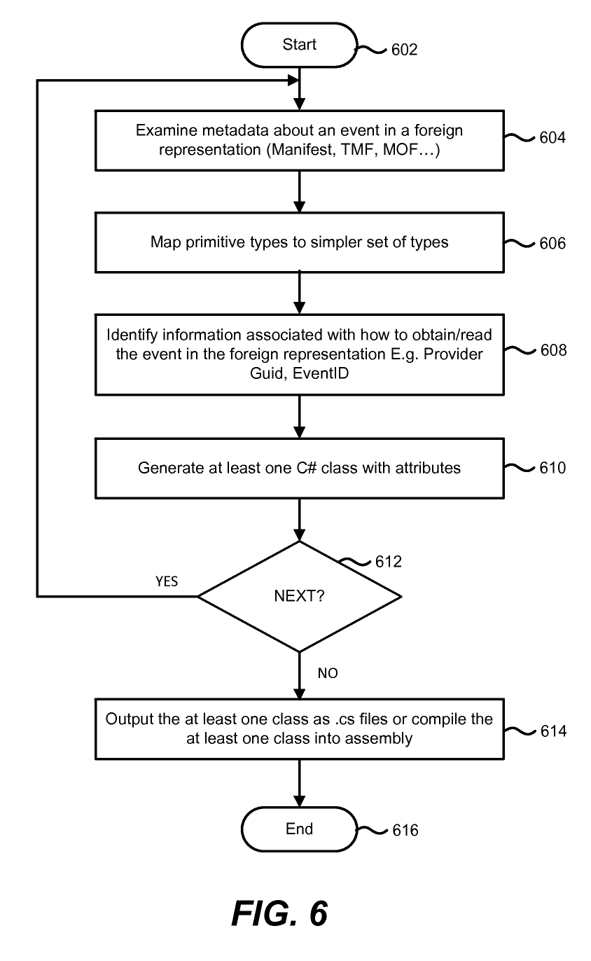

FIG. 6 is a flow diagram illustrating steps for generating C# classes associated with common event types. In one exemplary implementation, FIG. 6 refers to generating C# classes for implementing common event types. In one exemplary implementation, the generated C# classes form a repository of event structures to be used configuring an adapter to translate event data for executing a query as described herein.

Steps depicted in FIG. 6 commence at step 602 and proceed to step 604 where metadata about an event in a foreign representation is examined. Such a representation includes one or more data types, such as primitive data types, arrays, structures, collections and classes. In one exemplary implementation, the foreign representation is derived from a common data format, such as Managed Object Format (MOF). In an alternate implementation, the foreign representation includes a data format specified by a provider (e.g., a trace provider). Instructions for parsing and formatting the event in the foreign representation is published in a Manifest or a stored in provider source code. In yet another implementation, these instructions are extracted from the provider source code and stored as a file, such as a Trace Message Format file.

Step 606 represents mapping of one or more primitive types to simpler (i.e., generic) types. Because the foundation of a type system is the primitive types and corresponding representations, mapping the primitive types enables migration of other data types, such as arrays, classes and/or the like, to different type systems. For example, some type systems represent integers in big-endian order other than little-endian order. Hence, the generated C# classes defines abstract primitive types, such as integers and strings, to which various foreign representations map. For example, strings can be expressed differently in ASCII and Unicode when used by event tracing system (ETW) in an event log record. The C# class defines a common type that uses one string type.

Step 608 illustrating identification of information associated with how to obtain/read the event in the foreign representation. For example, while examining a structured text file comprising various events, the configuration mechanism 110 identifies an event of interest by a certain unique identifier, such as Provider GUID, EventID and/or the like. Each foreign representation of the event of interest is associated with a different unique identifier.

Step 610 represents generation of at least one C# class using attributes associated with the event in the foreign representation. Step 612 determinates whether there is a next event in the foreign representation to map onto the at least event structure. If there is a next event, step 602 to 612 is repeated. If there are no more events in the foreign representation to translate, step 614 represents an output of the at least one class as .cs files or compile the at least one class into assembly. Step 616 represents termination of the steps for generating C# classes associated with common event types.

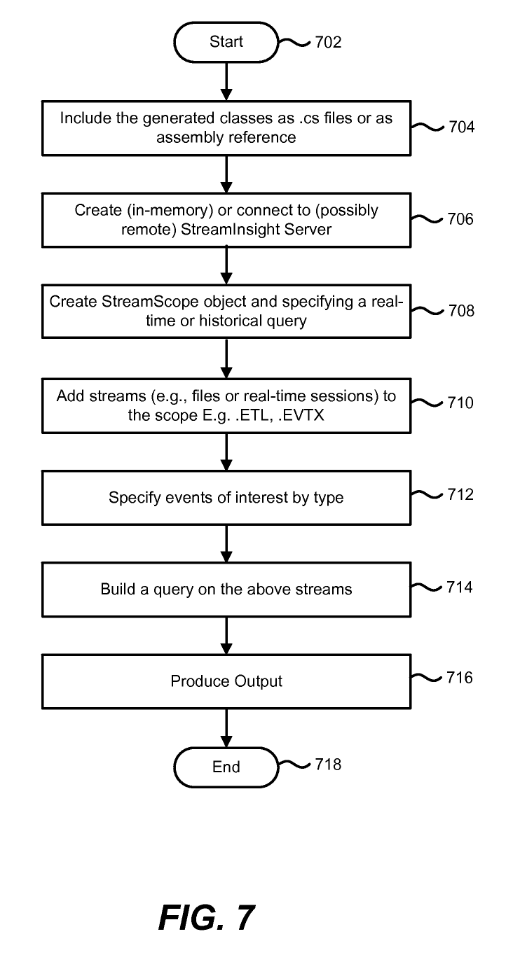

FIG. 7 is a flow diagram illustrating steps for building and executing a query that uses common event types. A software module performs step 702 to 720 by creating an interface (e.g., an Application Programming Interface (API)) for executing code that produces results for the query. Such an interface implements functions invoked by the code as described herein.

Step 704 represents the inclusion of one or more C# classes as .cs files or an assembly references. In other words, source code or object code representing the one or more C# classes is accessed by the code and used to instantiate objects for event types. As described herein, these objects enable translation of event data in a foreign representation into a custom representation, which is communicated to the software module as event streams.

Step 706 represents creating or connecting to an instance of a complex event processing platform, such as StreamInsight Server. Such an instance may be created in memory or accessed remoted as a network resource. Step 708 represents creating an object, such as a StreamScope object, that is configured to automatically generate information for translating the event data in the foreign representation.

Step 710 illustrates addition of streams to the object (e.g., a StreamScope object). These streams refer to files or real-time sessions of event processing. In one exemplary implementation, event logs, such as event trace logs (ETLs or EVTX files), are coupled to the object to allow access to the event data. Step 712 represents specifying one or more events of interest by type. Step 714 refers to building a query based on the streams. Such a query is executed using these event types. In one exemplary implementation, some of the query is executed on the adapters. Step 716 represents producing output for the executed query.

In one exemplary implementation, an expression “var parse=scope.GetEtwStream<Microsoft_Windows_HttpService.Parse>( )” retrieves “parse” events from a HTTPservice provider running on one or more sources. As described herein, data for the “parse” events is joined with “fastsend” events and used to aggregate HTTP request times. These results are displayed as a table showing a request id and a corresponding aggregate request time. Step 718 represents termination.

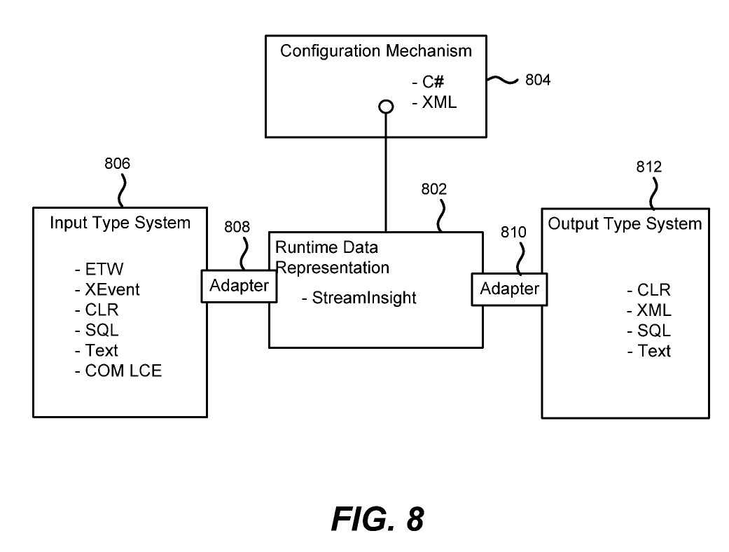

FIG. 8 is a block diagram representing an exemplary system for monitoring processes and providing event data in any representation. Each representation includes a format for organizing various data types, such as logical data types. The various data types include primitive data types, array, structures, classes and/or the like. Each representation provides level of abstraction from how data is stored in memory or disk. A foreign representation includes any representation that is not native to a complex event processing platform. In one exemplary implementation, a runtime representation 802 is a native representation and foreign representations include any representation used by event data sources and consumers.

A configuration mechanism 802, such as the configuration mechanism 110 of FIG. 1, automatically configures adapters with definitions indicating how to parse the event data in a particular data format, such as XEvent or XML. In one exemplary implementation, these definitions include classes, such as C# classes, indicating mappings between data fields of the particular format to attributes of the classes. Such classes, as described herein, refer to specific events that are used to produce results for a query.

The configuration mechanism 802 includes C# classes for converting event data in any representation to a runtime data representation 804 that supports various data formats (e.g., Complex Event Processing (CEP) Streams, such as Stream Insight streams, comprising events of various types) for organizing real-time events. In one implementation, the real-time events correspond with processes currently being executed and are stored in memory instead of disk. Once the processes terminate execution, the real-time events are transferred to a trace type system and become historical events. As described herein, the trace type system stores the historical events according to various data formats, such as CEP streams, event trace logs (e.g., ETL files associated with Event Tracing for Windows), Windows Event Logs and/or the like.

As illustrated in FIG. 8, an input type system 806 supports various data formats for organizing the event data related to numerous events, such as event trace logs, XEvents, SQL and/or the like. Each individual event is further organized according to an event structure that is generated by the configuration mechanism 802. In one exemplary implementation, while the configuration mechanism 802 configures an adapter 808 to identify all of the individual events and then, parse the event data using the event structure.

Subsequently, the adapter 808 translates the parsed event data into another data format, such as a CEP stream. After identifying one or more historical or real-time events having event data that matches the query, these results are communicated via an adapter 810 to an output type system 812. In one implementation, the configuration mechanism 802 configures the adapter 810 to parse the one or more historical or real-time events and translate the event data into yet another data format, such as CLR, XML, text and/or the like.

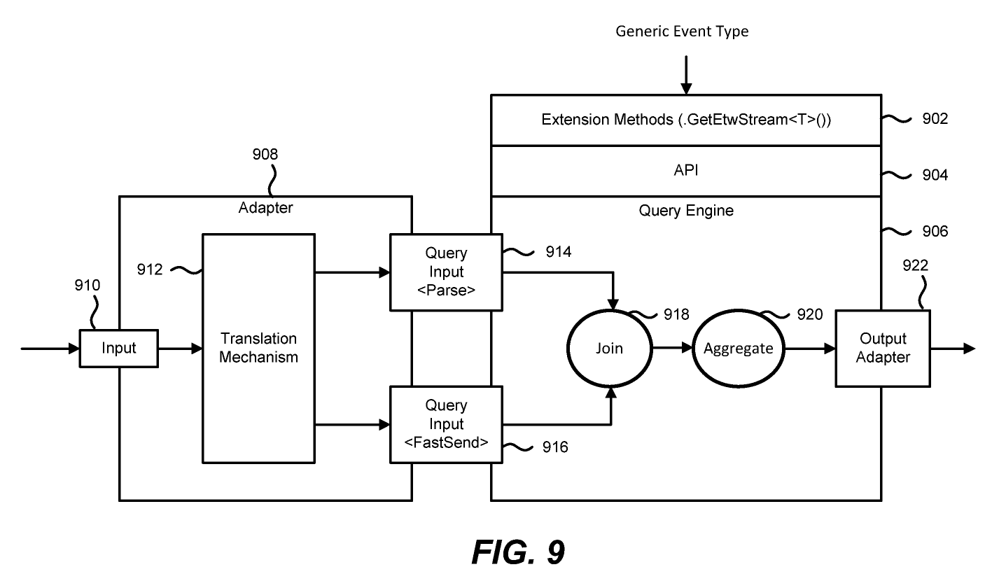

FIG. 9 is a block diagram illustrating query execution on real-time event data in a foreign representation. The query specifies one or more events by type via one or more extension methods 902. The one or more extension methods 902 implement functions for retrieving event streams where event data is translated from a foreign representation to a generic representation. The one or more extension methods 902 form a portion of an API 904 of an complex event processing platform. The API facilitates access to a query engine 906. The developers utilize the extension methods 902 to automatically configure an adapter 908 to perform the translation.

When one of the extension methods 902 is executed for an event type, components (e.g., data types) of the foreign representation are mapped to components of an event structure associated with the event type. Then, the extension method 902 generates one or more C# classes that implement the event structure. The query engine 906 determines an execution plan for a query. In one implementation, the query engine 906 produces a graph of operators, such as from, join or aggregate operators, and communicates configuration information comprising the generated C# classes to the adapter 908.

Within the adapter 908, the event data in the foreign representation is accessed as input 910. In one exemplary implementation, the input 910 a session comprising real-time event data. The adapter 908 prepares a translation mechanism 912 for recognizing events of interest from the input 910 and transforming such events into a corresponding event structure. For example, an event in an ETW native structure is translated into a generic “parse” event.

In one exemplary implementation, the translation mechanism 912 identifies event data for a query input <parse> event 914 and a query input <fastsend> event 916. The event data for the query input <parse> event 914 includes table data having such as a request id and URL as columns. Similarly, the event data for the query input <fastsend> event 916 includes table data having a request id in addition a status field.

The query engine 906 processes an execution plan for producing results for the query. Such an execution plan includes a graph of various operators that use attribute data associated with the “parse” and “fastsend” events. A join operator 918 combines the attribute data for both events using the request id as an index. An aggregate operator 920 uses resulting table data to determine a distribution of response times for all of the requests. An output adapter 922 converts aggregated table data into another data format.

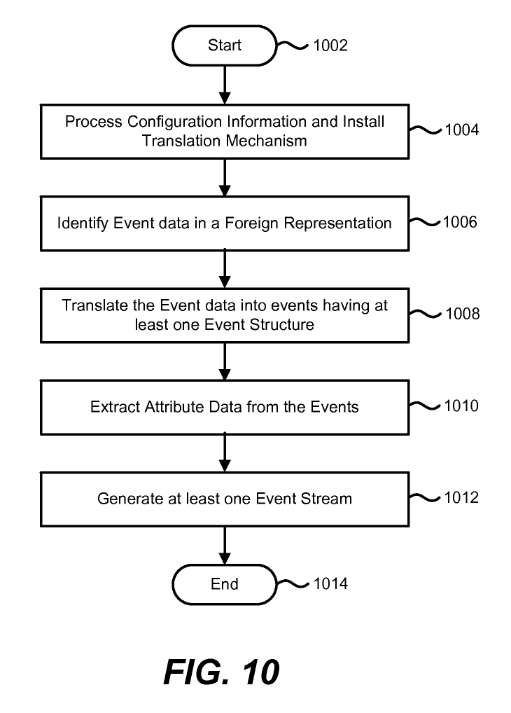

FIG. 10 is a flow diagram illustrating steps for transforming event data into at least one event stream using configuration information. Steps depicted in FIG. 10 commence at step 1002 and proceed to step 1004 when the configuration information is processed. In one implementation, the step 1002 to step 1014 are performed by various software modules, such as the adapter 108 of FIG. 1 as described herein.

Step 1006 is directed to identifying event data in a foreign representation. Using mappings between components of at least one event structure and components of the foreign representation, the adapter 108 identifies events of interest. In one exemplary implementation, a component includes an event GUID or a provider ID that matches an particular event stored by the source in the foreign representation.

Step 1008 is directed to translating the event data into events having the at least one event structure. Step 1010 refers to extracting attribute data from the events. Step 1012 refers to generating at least one event stream from the extracted attribute data. As described herein, the at least one event structure includes components describing certain attributes of the events. Portions of the event data that correspond with these components are extracted and stored in the at least one event stream. Hence, the attribute data is arranged within the at least one stream in accordance with the at least one event structure. Step 1014 refers to terminating the steps for transforming event data into at least one event stream using the configuration information.

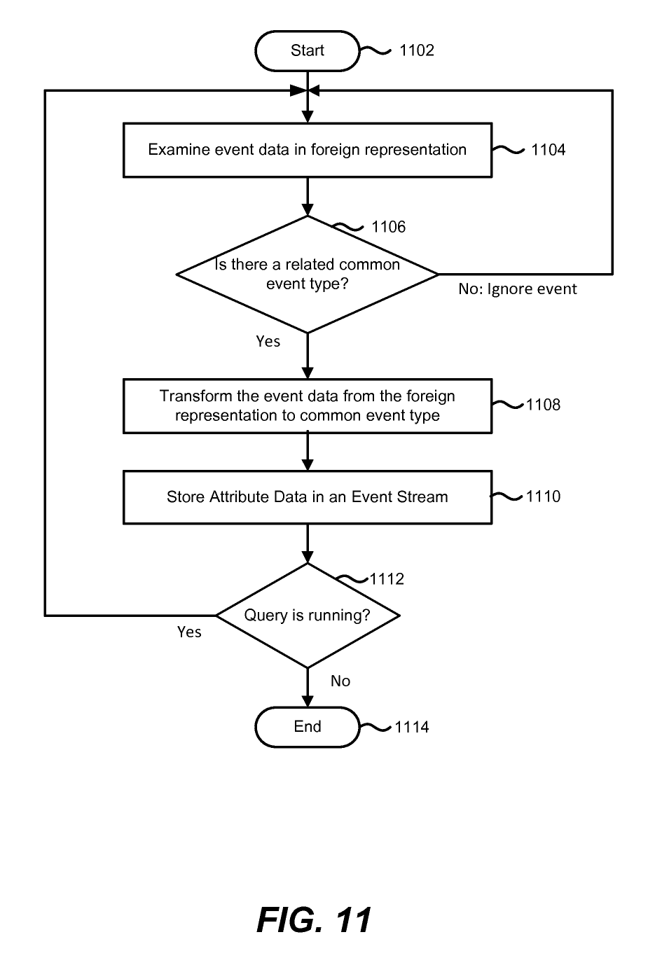

FIG. 11 is a flow diagram illustrating steps for responding to a query using configuration information. Steps depicted in FIG. 11 commence at step 1102 and proceed to step 1104 where an event in a foreign representation is identified. In one implementation, the step 1102 to step 1114 are performed by various software modules, such as the adapter 108 of FIG. 1 as described herein.

Step 1106 represents a determination as to whether there is a specific event type to which the event in the foreign representation can transform. If there is no such event type, the event is ignored and step 1104 is repeated for another event in the foreign representation. If there is a specific event type that maps to the event, step 1108 transforms the event into a data format used by complex event processing platforms. Step 1110 illustrates communication of the transformed event to a query engine. Step 1112 determines whether the query engine is still processing a query. If the query engine is still using event data to execute the query, step 1104 to 1112 is repeated for another event. If the query engine completed the execution, step 1114 terminates event data translation.

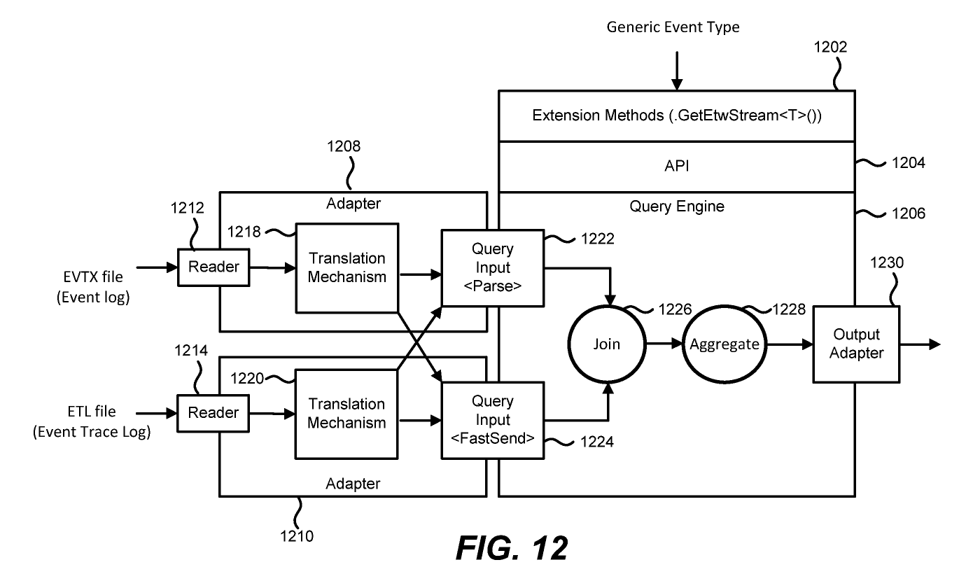

FIG. 12 is a block diagram illustrating query execution on historical event data in a foreign representation. The query specifies one or more events by type via one or more extension methods 1202. The one or more extension methods 1202 implement functions for retrieving event streams where historical event data is translated from a foreign representation to a custom representation. The one or more extension methods 1202 form a portion of an API 1204 of an complex event processing platform. The API facilitates access to a query engine 1206. The developers utilize the extension methods 1202 to automatically configure an adapter 1208 and an adapter 1210 to perform the translation.

When one of the extension methods 1202 is executed for an event type, components (e.g., data types) of the foreign representation are mapped to components of an event structure associated with the event type. Then, the extension method 1202 generates one or more C# classes that implement the event structure. The query engine 1206 determines an execution plan for a query. In one implementation, the query engine 1206 produces a graph of operators, such as from, join or aggregate operators, and communicates configuration information comprising the generated C# classes to the adapter 1208 and adapter 1210.

Within the adapter 1208 and the adapter 1210, the historical event data in the foreign representation is retrieved via a reader 1212 and a reader 1214, respectively. Furthermore, the adapter 1208 and the adapter 1210 prepare a translation mechanism 1218 and a translation 1220, respectively. The reader 1212 retrieves the historical event data from an event log (e.g., an .EVTX file) from which the translation mechanism 1218 identifies one or more “parse” events and “fastsend” events. Similarly, the reader 1214 retrieves the historical event data is retrieved from event data from an event trace log (e.g., an .ETL file) from which the translation mechanism 1220 identifies one or more additional “parse” events and “fastsend” events.

In one exemplary implementation, the one or more “parse” events and one or more additional “parse” events are stored in a query input <parse> event 1222. The one or more “fastsend” events and one or more additional “fastsend” events are stored in a query input <fastsend> event 1224. Generally, an “parse” event or a “fastsend event” are generic C# object instances that are created from the C# classes that define them. For example, events identified from an .EVTX file are stored as generic C# objects of type EventLogRecord. If one of the events is a “parse” event, a corresponding C# object includes a URL as a component.

The historical event data for the query input <parse> event 1222 includes table data having such as a request id and URL as columns. Similarly, the historical event data for the query input <fastsend> event 1224 includes table data having a request id in addition a status field. A join operator 1226 combines the event data for both events using the request id as an index. An aggregate operator 1228 uses resulting table data to determine a distribution of response times for all of the requests. An output adapter 1230 converts aggregated table data into a data format used at a source.

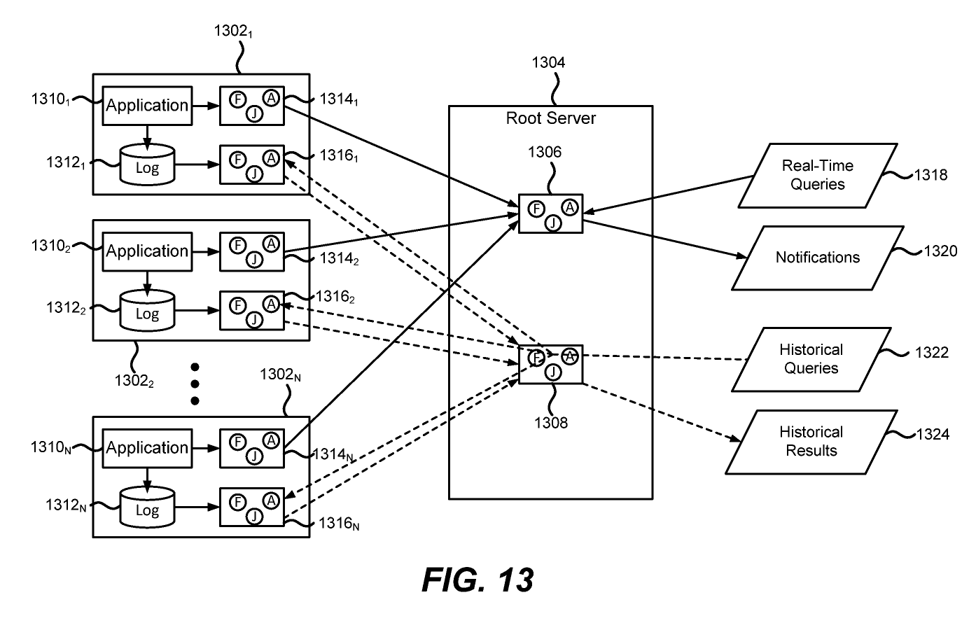

FIG. 13 is a block diagram representing an exemplary system for executing a distributed query for real-time or historical events across a plurality of sources 1302_{1 . . . N}. A plurality of sources 1302_{1 . . . N} execute a query provided by a server 1304 using historical events or real-time events. The server 1304 is similar to the server 102 of FIG. 1 and includes a server instance 1306 and a server instance 1308 of a complex event processing platform.

In one exemplary implementation, the plurality of sources 1302_{1 . . . N} vary in number from one or two computers to a data center comprising thousands of computers. Sources are added or removed from the plurality of sources 1302_{1 . . . N} without affecting the execution of the distributed query. Because the plurality of sources 1302_{1 . . . N} use generated C# classes for common event types, a developer does not to configure another adapter with a new data format when a source is added or reconfigure any existing adapters when a source id removed.

Each source 1302 includes an application 1310 that writes events to a log 1312. Each application 1310 includes any software application implementing an event data provider that publishes schemas for each event type. These schemas may be referred to foreign representations in the present disclosure. Each schema is derived from a common format (e.g., Managed Object Format (MOF). For each event, the event data provider registers a unique identifier (GUID) and instantiates an object according to the schema to store event data according to one exemplary implementation. Alternatively, the event data provider publishes a custom event type schema in an instrumentation manifest as described herein.

Each of the plurality of sources 1302_{1 . . . N} includes an agent 1314 and an agent 1316 for providing query results to the root server 1404. The agent 1314 and the agent 1316 include a configuration mechanism for automatically generating information for identifying the real-time events and the historical events, respectively. Furthermore, the agent 1314 and the agent 1316 implement a query engine that applies an execution plan for the query to operators. When attribute data for the real-time events or the historical events is available, the operators perform various components using the attribute data.

The various operations include filter, join and aggregate, which are illustrated in FIG. 13 as “F”, “J” and “A” respectively. After identifying each event by type, each operation modifies associated event data according to a query. For example, the agent 1314 identifies events in response to a real-time query 1318 and/or provides a notification 1320 comprising events that match the real-time query 1318. As another example, the agent 1316 identifies events in response to a historical query 1322 and/or provides results 1324 comprising events that match the historical query 1322.

In one exemplary implementation, if the historical query 1322 requests performance counters that indicate processor usage exceeding a threshold limit (e.g., 50%). After compiling a table of processor usage statistics over a given time period, each of the agent 1316 filters such a table and identifies performance counters where the processor usage exceeds the threshold limit. In an alternate implementation, the real-time query 1318 requests performance counters that indicate when current disk space falls below an established minimum (e.g., 1 gigabyte). Each of the plurality of adapters 1312 communicates the notifications 1320 whenever such a condition is satisfied.

As another example, if the historical query 1322 requests start and end times for system processes. In response, each of the agent 1316 joins a table of start times for all processes with a table of end times and uses an identifier as an index of the joined table (e.g., event identifier, process identifier, provider identifier and/or the like). Basically, each row of the joined table includes a start and end time for executing a specific process. Furthermore, if the historical query 1322 requests start and end times for processes that exceed a duration (e.g., five seconds), the joined table is then filtered in order to remove processes that completed execution within the duration.

In yet another example, if the historical query 1322 requests start and end times for processes that exceed the duration and run on a massive number of computers where such processes exceed a specific percentage (e.g., five (5) %) of a total number of processes. The each of the agent 1316 collects start and end times associated with a particular interval (e.g., one minute) into a table. Then, the each of the agent 1316 filters the table for processes took longer than the duration. Lastly, the configuration mechanism 1308 aggregates the table with similarly filtered tables associated with each and every previous interval and determines whether the computers execute more than the specific percentage of total processes in excess of the duration. Because the filtering of table data is performed by the agent 1316 prior to communication to the server 1304, significant savings in network bandwidth consumption is achieved.

In one implementation, automatically configuring the plurality of adapters 1316 enables the historical events to be replayed once for all requested events instead of once per event. For example, if multiple historical queries 1322 request resource usage averages or standard deviations for a processor, memory, a physical disk and a network, the configuration mechanism 1308 combines the multiple historical queries 1322 into a single query prior to the automatic configuration. The agent 1316 reads log files comprising the historical events only once. As a result, a table is generated comprising a column for each resource that indicates a percentage of a total available capacity being consumed at different points in time. Replaying the log files only once for multiple queries is advantageous when such log files are large in size or the plurality of sources 1302 is massive in number.

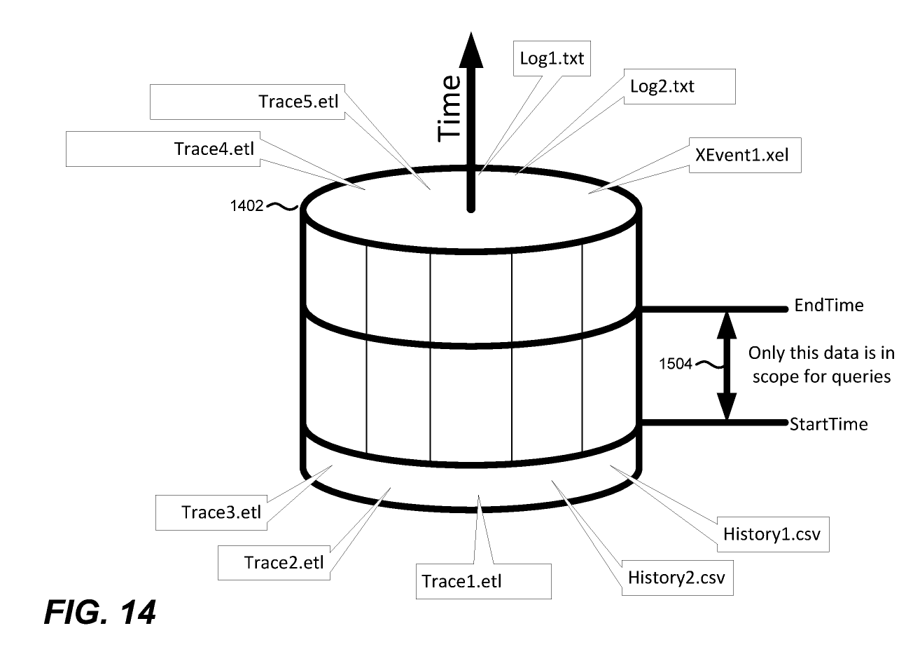

FIG. 14 is a graphical representation 1402 illustrating physical streams for executing a query. The graphical representation 1402 includes two captures of performance counters (.CSV files), five ETW traces (.ETL files), two text logs (i.e., event logs) and one .XML file from XEvents (.xel).

Despite the number of physical streams, a configuration mechanism uses generic events to configure an adapter running on a source as described herein. Each generic event type is defined by one or more event structures, such as generic C# objects, having components that apply to all event types. For example, components StartTime and EndTime for each event is retrieved from all of the physical streams. Using these components, only event data stored in portion 1404 of the physical streams is translated and used to execute the query. Note that in some exemplary implementations, a physical stream includes events of various types—e.g. beginning of HTTP request (Parse) and end of HTTP request (FastSend). Furthermore, a same event type can occur in more than one physical stream. For example, .ETL traces are retrieved from different web servers.

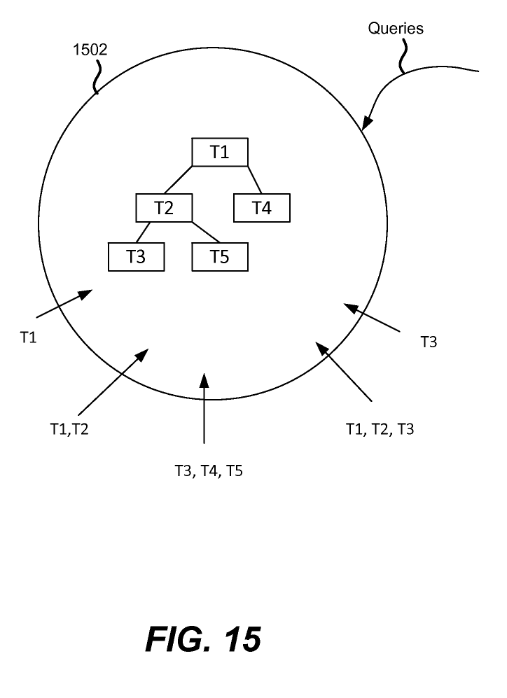

FIG. 15 illustrates an event stream 1502 in a perspective of a developer. Specifically, the event stream 1502 includes various events as one single event stream. T1-T5 include event structures that form a hierarchy. For example, event structure T4 is a leaf event that implements a particular version of a root event type defined in T1. In one exemplary implementation, T4 implements a “parse” event for a HTTPservice provider that is derived from a generic system event. As another example, T3 and T5 implement event structures derived from root event T2, which itself derives from T1.

When examining the event stream 1502, events are identified as leaf events and flow up to a root event where events from different sources are combined. Accordingly, a user requests event data for a particular event type regardless of source. For example, requesting each and every instance of the leaf event T3 returns combined event data from all three sources of such an event. As another example, requesting each and every instance of the root event T2 returns combined event data from a source of the root event T2, all three sources of the leaf event T3 and a source of leaf event T5. Requesting root event T1 returns all of the events from all of the sources.

### Exemplary Networked and Distributed Environments

One of ordinary skill in the art can appreciate that the various embodiments and methods described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the resource management mechanisms as described for various embodiments of the subject disclosure.

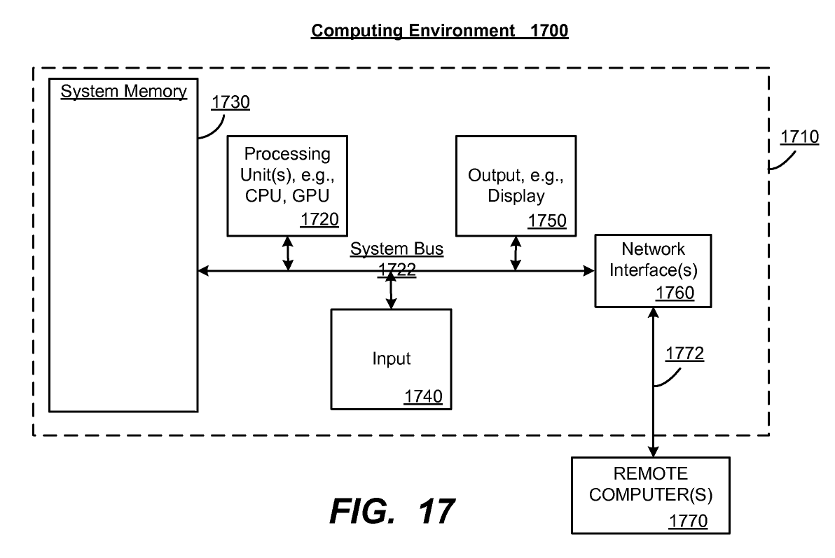

FIG. 17 provides a schematic diagram of an exemplary networked or distributed computing environment. The distributed computing environment comprises computing objects 1710, 1712, etc., and computing objects or devices 1720, 1722, 1724, 1726, 1728, etc., which may include programs, methods, data stores, programmable logic, etc. as represented by example applications 1730, 1732, 1734, 1736, 1738. It can be appreciated that computing objects 1710, 1712, etc. and computing objects or devices 1720, 1722, 1724, 1726, 1728, etc. may comprise different devices, such as personal digital assistants (PDAs), audio/video devices, mobile phones, MP3 players, personal computers, laptops, etc.

Each computing object 1710, 1712, etc. and computing objects or devices 1720, 1722, 1724, 1726, 1728, etc. can communicate with one or more other computing objects 1710, 1712, etc. and computing objects or devices 1720, 1722, 1724, 1726, 1728, etc. by way of the communications network 1740, either directly or indirectly. Even though illustrated as a single element in FIG. 17, communications network 1740 may comprise other computing objects and computing devices that provide services to the system of FIG. 17, and/or may represent multiple interconnected networks, which are not shown. Each computing object 1710, 1712, etc. or computing object or device 1720, 1722, 1724, 1726, 1728, etc. can also contain an application, such as applications 1730, 1732, 1734, 1736, 1738, that might make use of an API, or other object, software, firmware and/or hardware, suitable for communication with or implementation of the application provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, e.g., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 17, as a non-limiting example, computing objects or devices 1720, 1722, 1724, 1726, 1728, etc. can be thought of as clients and computing objects 1710, 1712, etc. can be thought of as servers where computing objects 1710, 1712, etc., acting as servers provide data services, such as receiving data from client computing objects or devices 1720, 1722, 1724, 1726, 1728, etc., storing of data, processing of data, transmitting data to client computing objects or devices 1720, 1722, 1724, 1726, 1728, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server.

In a network environment in which the communications network 1740 or bus is the Internet, for example, the computing objects 1710, 1712, etc. can be Web servers with which other computing objects or devices 1720, 1722, 1724, 1726, 1728, etc. communicate via any of a number of known protocols, such as the hypertext transfer protocol (HTTP). Computing objects 1710, 1712, etc. acting as servers may also serve as clients, e.g., computing objects or devices 1720, 1722, 1724, 1726, 1728, etc., as may be characteristic of a distributed computing environment.

### Exemplary Computing Device

As mentioned, advantageously, the techniques described herein can be applied to any device. It can be understood, therefore, that handheld, portable and other computing devices and computing objects of all kinds are contemplated for use in connection with the various embodiments. Accordingly, the below general purpose remote computer described below in FIG. 18 is but one example of a computing device.

Embodiments can partly be implemented via an operating system, for use by a developer of services for a device or object, and/or included within application software that operates to perform one or more functional aspects of the various embodiments described herein. Software may be described in the general context of computer executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol is considered limiting.

FIG. 18 thus illustrates an example of a suitable computing system environment 1800 in which one or aspects of the embodiments described herein can be implemented, although as made clear above, the computing system environment 1800 is only one example of a suitable computing environment and is not intended to suggest any limitation as to scope of use or functionality. In addition, the computing system environment 1800 is not intended to be interpreted as having any dependency relating to any one or combination of components illustrated in the exemplary computing system environment 1800.

With reference to FIG. 18, an exemplary remote device for implementing one or more embodiments includes a general purpose computing device in the form of a computer 1810. Components of computer 1810 may include, but are not limited to, a processing unit 1820, a system memory 1830, and a system bus 1822 that couples various system components including the system memory to the processing unit 1820.

Computer 1810 typically includes a variety of computer readable media and can be any available media that can be accessed by computer 1810. The system memory 1830 may include computer storage media in the form of volatile and/or nonvolatile memory such as read only memory (ROM) and/or random access memory (RAM). By way of example, and not limitation, system memory 1830 may also include an operating system, application programs, other program modules, and program data.

A user can enter commands and information into the computer 1810 through input devices 1840. A monitor or other type of display device is also connected to the system bus 1822 via an interface, such as output interface 1850. In addition to a monitor, computers can also include other peripheral output devices such as speakers and a printer, which may be connected through output interface 1850.

The computer 1810 may operate in a networked or distributed environment using logical connections to one or more other remote computers, such as remote computer 1870. The remote computer 1870 may be a personal computer, a server, a router, a network PC, a peer device or other common network node, or any other remote media consumption or transmission device, and may include any or all of the elements described above relative to the computer 1810. The logical connections depicted in FIG. 18 include a network 1872, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve efficiency of resource usage.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements when employed in a claim.

As mentioned, the various techniques described herein may be implemented in connection with hardware or software or, where appropriate, with a combination of both. As used herein, the terms “component,” “module,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described herein, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, some illustrated blocks are optional in implementing the methodologies described hereinafter.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention is not to be limited to any single embodiment, but rather is to be construed in breadth, spirit and scope in accordance with the appended claims.

What is claimed is:

1. In a computing environment, a method performed at least in part on at least one processor, comprising:
processing at least one query corresponding to event data, including automatically generating configuration information that defines at least one event structure associated with the at least one query, applying the configuration information to at least one adapter, wherein the at least one adaptor uses the at least one event structure to transform the event data into at least one event stream, and examining the at least one event stream to produce results for the at least one query.

2. The method of claim 1, wherein the event data comprises real-time event data or historical event data.

3. The method of claim 1, wherein applying the configuration information further comprises instructing the at least one adapter to translate the event data from a foreign representation into at least one event corresponding with the at least one event structure.

4. The method of claim 1, wherein applying the configuration information further comprising configuring the at least one adapter to identify at least one event having the at least one event structure from the event data.

5. The method of claim 4, wherein the at least one adapter is further configured to extracting attribute data from the at least one event, wherein the attribute data is associated with components of the at least one event structure.

6. The method of claim 1, wherein automatically generating the configuration information further comprises accessing at least one identifier associated with at least one event in the event data or at least one provider of the at least one event.

7. The method of claim 1, wherein the at least one event structure comprises at least one generated event class for a real-time session or a file.

8. The method of claim 1, wherein applying the configuration information further comprises providing at least one identifier associated with at least one manifest based provider.

9. The method of claim 1, wherein generating the configuration information further comprises mapping components of the at least one event structure to components of at least one data format for representing the event data.

10. In a computing environment, a system, comprising:
a configuration mechanism for mapping at least one component of at least one data format to at least one component of at least one event structure, wherein the data format represents event data used by at least one source and requesting at least one event stream from at least one adapter running on the at least one source, wherein the at least one adapter translates the event data into attribute data corresponding with the at least one component of the at least one event structure and creates the at least one stream using the attribute data.

11. The system of claim 10, wherein the at least one adapter uses at least one identifier associated with at least one event or at least one provider to translate the event data from a foreign representation into at least one event having the at least one event structure.

12. The system of claim 10, wherein the configuration mechanism examines the at least one event stream to produce results for at least one query.

13. The system of claim 10, wherein the configuration mechanism defines the at least one event structure based on at least one query for the event data.

14. The system of claim 10 further comprising a query engine for processing an execution plan for at least one query, wherein the execution plan uses the at least one event structure to identify attribute data within the at least one event stream.

15. The system of claim 10, wherein the at least one adapter identifies events within the event data using the at least one component of the at least one data format.

16. The system of claim 10, wherein the configuration mechanism generates information for configuring the at least one adapter to perform event data translation using at least one generated event class for a real-time session or a file.

17. The system of claim 10, wherein the at least one adapter generates the at least one event stream using at least one identifier associated with at least one manifest based provider.

18. One or more computer-readable media having computer-executable instructions, which when executed perform steps, comprising:
in response to at least one query for event data, automatically configuring at least one adapter running on the at least one source with at least one event structure, wherein the at least one adaptor translate the event data from a foreign representation into at least one event having the at least one event structure;
processing the at least one event stream using an execution plan for identifying attribute data within the at least one event stream; and
producing results for the at least one query using the attribute data.

19. The one or more computer-readable media of claim 17 having further computer-executable instructions comprising:
accessing at least one identifier associated with at least one manifest based provider.

20. The one or more computer-readable media of claim 17 having further computer-executable instructions comprising:
defining at least one event structure using at least one generated event class for a real-time session or a file.
